(19) United States
(12) Patent Application Publication
(10) Pub. No.: US 2013/0151167 A1
(43) Pub. Date: Jun. 13, 2013

(54) Method To Determine The DRA In A Hydrocarbon Fuel

(71) Applicant: MARATHON PETROLEUM COMPANY LP, Findlay, OH (US)

(72) Inventor: Eric Shawn Broughton, Russell, KY (US)

(73) Assignee: MARATHON PETROLEUM COMPANY LP, Findlay, OH (US)

(21) Appl. No.: 13/705,306

(22) Filed: Dec. 5, 2012

Related U.S. Application Data
(60) Provisional application No. 61/568,335, filed on Dec. 8, 2011.

(51) Int. Cl. G06F 19/00

(52) U.S. Cl. CPC G06F 19/705
USPC 702/25

(57) ABSTRACT

This instrumental method requires no sample preparation to determine not only whether a fuel contains DRA, but also the manufacturer(s) of the DRA. To date, there is no available method to quickly and easily perform this analysis. Only 60 microliters of sample are needed for the determination, which can be performed within two hours.

### FIELD OF THE INVENTION

The invention relates to the detection of “drag reducer additives” (DRA) in liquid hydrocarbon fuels. More specifically, the invention relates to a method to determine the presence and manufacturer of DRA Dissolved in a Hydocarbon Fuel.

### BACKGROUND OF THE INVENTION

In order to move fluid through pipelines, into or out of wells, or through equipment, energy must be applied to the fluid. The energy moves the fluid, but is lost in the form of friction. This frictional pressure drop, or drag, restricts the fluid flow, limiting throughput and requiring greater amounts of energy for pumping.

Materials can be added to flowing fluids in order to reduce the energy lost due to friction, or drag, thus permitting the movement of more fluid at the same differential pressure. The resulting reduction in frictional pressure drop improves pumping efficiency, lowers energy costs, and increases profitability. Materials for reducing drag in flowing fluids are generally known as “drag reducer additive” (DRA).

Unfortunately, whether in the virgin form or in the sheared or partially sheared form, and despite the fact that it is intentionally added to certain fuels, drag reducer additive nonetheless is a “contaminant” in liquid hydrocarbon fuels, and has the potential to cause a number of problems.

Methods of detecting and quantifying drag reducer additive in liquid hydrocarbon fuels commonly are time consuming and expensive. Often, large samples are used.

### DETAILED DESCRIPTION OF THE INVENTION

This instrumental method requires no sample preparation to determine whether a fuel contains DRA. The instrument also determines the manufacturer(s) of the DRA. To date, there is no available method to quickly and easily perform this analysis. Only 60 microliters of sample are needed for the determination, which can be performed within two hours.

A Quantum Analytics Pryolysis add-on, containing an autosampler, multiple-zone furnace, and cryogenic trapping apparatus is fitted to a Gas Chromatograph with Mass selective detector.

DRA (Drag Reducing Agent (or Additive)) is used within the pipeline industry to lower the cost of transporting hydrocarbons through the system by reducing pumping forces. The additive is either a singular or multi-type of polymerized alpha olefin(s). It is added into the fuel at anywhere from 0.5 to 14 ppm polymer content. Because of this low concentration, and the polymer's chemical similarity to the hydrocarbon fuel in which it is dissolved, detection by normal analytical methods is extremely difficult. A pyrolysis attachment onto a GC-MS that can fractionate the sample into various boiling point ranges. The system then removes most of the hydrocarbon fuel, leaving the polymer, which is at sufficiently high enough concentration to analyze.

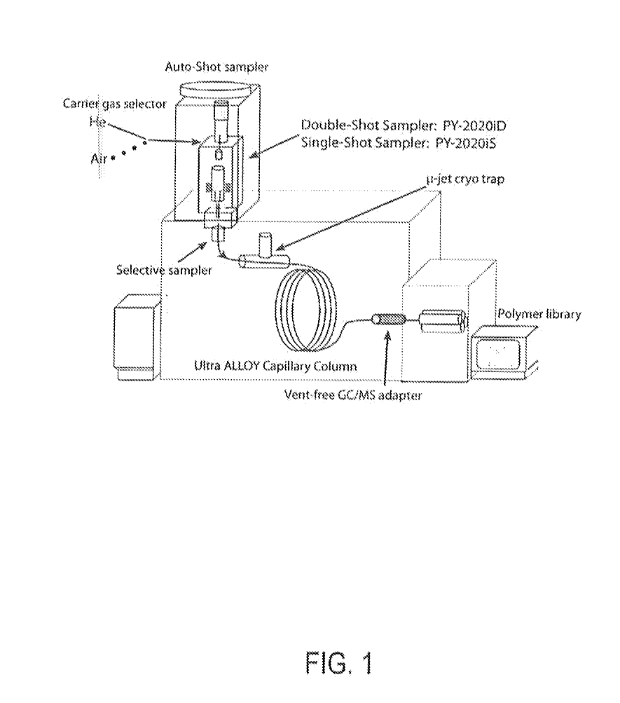

FIG. 1 shows a multi-functional pyrolyzer coupled with a gas chromatograph. Most liquids and solids can be chemically characterized using five powerful thermal techniques.

Evolved Gas Analysis (EGA) provides a thermal profile of the sample. A short 2.5 m deactivated capillary tube connects the Multi-Functional Pyrolyzer and the GC detector. As the sample temperature increases, compounds “evolve” from the sample matrix and are detected. EGA enables one to determine the complexity of the sample, the presence of volatile compounds and the proper pyrolysis temperature.

In Thermal Desorption (TD) Analysis the furnace temperature is programmed up and compounds are desorbed as a function of their boiling points. The compounds are first cold trapped at the head of the column and then chromatographically separated and detected.

In “Single Shot” Analysis, pyrolysis is used for macromolecular and other non-volatile materials. When a sample is rapidly heated to high temperatures, chemical bonds are broken. The resulting fragments are chromatographically separated, producing a pyrogram. The pyrogram is used to characterize the nature of the original sample.

“Double-Shot” is the unique combination of Thermal Desorption (TD) and Pyrolysis (Py). TD is used to identify volatile compounds in the sample such as residual solvents, reaction products, monomers, and additives like antioxidants and stabilizers. Py is used to characterize the polymer.

EGA GC/MS Analysis is used to profile the sample components. Each fraction of the sample can be automatically collected, analyzed and characterized using heart cutting techniques.

A search for polymer identification utilizes an algorithm to tentatively identify samples based on their GC/MS program or EGA profile.

Carrier gas selector enables the operator to select between two gases. Helium is normally used. Air and oxygen are used when performing reaction pyrolysis.

Auto-Shot sampler analyzes up to 48 samples using three different operating modes.

With μ-jet cryo trap compounds are focused at the head of the column in prior to analysis using nitrogen cooled to −196° C.

Sample fractions can be automatically vented (i.e., cut) or directed to the analytical column.

Ultra Alloy EGA tube and capillary columns is multi-step process yields a deactivated stainless steel surface which is stable at temperatures greater than 400° C.

Vent-free GC/MS adapter enables the operator to change the columns without venting the MS.

In thermal desorption (TD), the sample cup is dropped into the μ-furnace at 40° C. The furnace is programmed to 320° C. at 20° C./min. The volatile compounds are reconcentrated using the μ-jet cold trap. The GC subsequently separates the desorbed volatile compounds. The mass spectra are used to identify each compound.

Once the thermal desorption is complete, the sample cup is lifted out of the μ-furnace. The furnace is heated to 600° C. and the sample cup is dropped back into the furnace. The non-volatile portion of the sample is pyrolyzed. The resulting pyrogram can be matched with standard pyrograms using the pyrolsis library.

The search may consist of two libraries based on GC/MS data: one contains EGA thermograms and the other Py pyrograms. The libraries use a search algorithm which enables one to identify unknown polymeric materials rapidly. The libraries contain averaged GC/MS data for hundreds of polymers. One can easily edit or customize the libraries to fit specific applications.

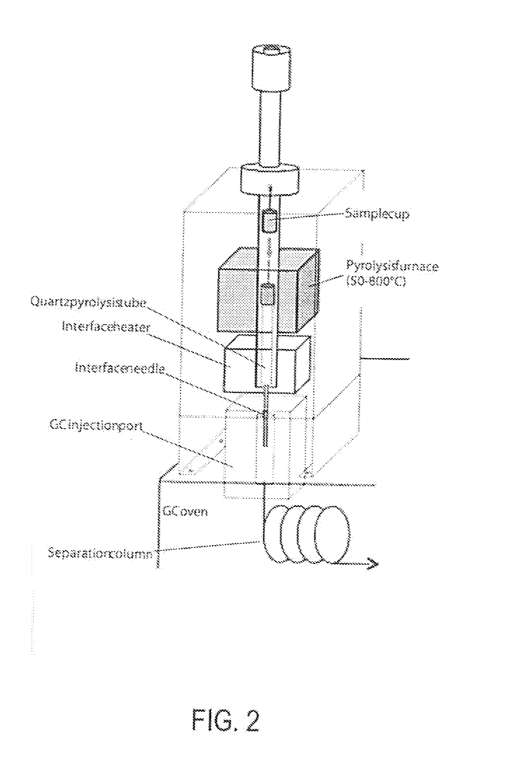

FIG. 2 illustrates another multi-functional pyrolyzer and gas chromatograph. FIG. 2 shows quantum analytics. Quantum proxies an array of sample preparation and introduction of products. Products available include: pyrolysis, thermal desorption, headspace, purge and trap, high throughput autosampling. RFID tracking, large volume inlets, and preparative fraction collection. An example of pre-injection liquid manipulation is as follows. A sample of derivatization agent may be added, the sample vial heated, mixed and then injected into the system.

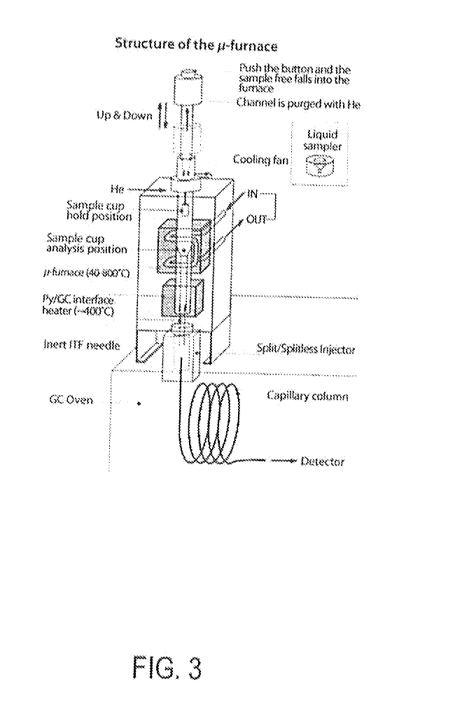

FIG. 3 illustrates gas chromatograph and pyrolyzer wherein the pyrolyer is based upon a vertical μ-furnace. The sample goes from ambient to the furnace temperature in less than 20 ms. The sample falls to the same position within the furnace every time, and the furnace temperature is calibrated at the sample location so that the selected temperature is the actual temperature. A separate interface heater ensures thermal homogeneity. There is no transfer line and no polymeric material in the sample path. An contact surfaces are quartz.

Only the compounds evolving from the sample over a selected temperature range are transferred to the column and chromatographically separated. Analyzing in each zone independently generally results in a simple chromatogram. Analysis time is sharply reduced and instrument contamination essentially is eliminated by analyzing only the portion of sample that are of interest.

### EXAMPLE I

Quantum Analytic Pyrolysis add-on, containing an autosampler, multiple-zone furnace, and cryogenic trapping apparatus is fitted to a Gas Chromatograph with Mass Selective detector. A programmatic method is enabled on the instrument which fractionates the raw sample into three cuts (fractions) based on boiling point. The first fraction, (designated, as A) contains mostly the fuel, and may be analyzed on the GC, though it is not necessary for obtaining information about the DRA. The second fraction (B)) contains some of the fuel, and possible information on the solvent carrier (may or may not contain this information, which varies by type and manufacturer of the DRA). For example, manufacturer X may make two different DRAs that vary only by solvent carrier—the active polymer will be identical. One solvent is a heavy soy oil, and the other is a light ketone. The soy oil will appear in fraction B, while the ketone will not. The third fraction (C) contains information about the polymer (the active ingredient of interests) in the DRA. This fraction is heated to temperatures high enough to pyrolyze the polymer, thereby breaking it into smaller molecular fractions that can be analyzed by a ‘normal’ GC-MS. These molecular fractions form the fingerprint that is unique to each manufacturer. A library of nearly all manufacturers has been developed.

For DRA in very low concentration within a fuel (<c.a. 4 ppm polymer), the MS may be operated in Select Ion Monitoring mode, as not only is there a unique distribution of pyrolyzed polymer, but there is predominant peak on the SC chromatogram that contains a unique ion distribution (see attachment). Searching for this ion distribution is much more Sensitive than the usual Total Ion Count method.

### EXAMPLE II/PRIOR ART

A fuel terminal comprises a DRA adsorption unit comprising cylindrical Vessel containing 10,000 pounds of an effective removal agent comprising activated carbon A. The vessel is constructed in an up low design that allows liquid hydrocarbon fuel to enter at the bottom of the vessel and leave from the top. The DRA adsorption unit is located between the fuel storage tanks and the loading rack used by customers that purchase tanker truck quantities of fuel. The adsorption unit further comprises a bypass valve and loop that allows fuel to bypass the adsorption unit as it is pumped from a given terminal storage tank to the loading rack.

Each terminal tank of fuel is tested using activated carbon A as a detection agent. When the test indicates that DRA is present in a tank of liquid hydrocarbon fuel, the bypass valve to the adsorption unit is closed, thereby directing the liquid hydrocarbon fuel containing the DRA to pass from the tank and through the adsorption unit. When the test indicates that DRA is not present, the bypass valve is opened, thereby causing the fuel to bypass the adsorption unit as it is pumped from that terminal storage tank to the loading rack.

The 10,000 pound vessel of activated carbon removes the DRA from up to 372,000 gallons of the gasoline in the terminal tank.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

I claim:

1. A method for detecting the presence of drag reducer additive in a liquid hydrocarbon fuel, comprising the steps of
providing a pyrolysis chamber to a gas chromatograph;
feed a sample liquid hydrocarbon fuel which may contain a drag reduce additive (DRA) therein to the pyrolysis chamber;
heating the sample in the pyrolysis chamber at a temperature high enough to pyrolize the hydrocarbon;
feeding the heated sample from the pyrolysis chamber to the gas chromatograph;
analyzing the heated sample in the gas chromatograph; and
comparing the analysis to a library of DRA samples to determine the DRA and it's manufacturer.

2. A method according to claim 1 wherein the pyrolysis chamber is a Quantum analytic Pyrolysis add-on.

3. A method according to claim 1 wherein the pyrolysis chamber further comprises a multiple-zone furnace and cryogenic trapping apparatus.

4. A method according to claim 1 wherein the gas chromatograph further comprises a Mass Selective detector.

5. A method according to claim 1 wherein the library is a search algorithm of multiplicity of polymers.

6. A method according to claim 1 wherein the algorithm further comprises averaged GC/MS data for the polymers.
